(19) United States
(12) Patent Application Publication
(10) Pub. No.: US 2008/0238801 A1
(43) Pub. Date: Oct. 2, 2008

(54) Conductor Having Two Frequency-Selective Surfaces

(76) Inventor: Lawrence Ragan, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 12/056,951

(22) Filed: Mar. 27, 2008

Related U.S. Application Data
(60) Provisional application No. 60/908,712, filed on Mar. 29, 2007.

(51) Int. Cl. H01Q 19/10

(52) U.S. Cl. 343/834

(57) ABSTRACT

An antenna having two frequency-selective surfaces is disclosed. The antenna includes a first frequency-selective surface (FSS) having multiple holes to form a mesh, a second FSS having a multiple holes to form a mesh, and a perfect electric conductor located between the first FSS and the second FSS.

### PRIORITY CLAIM

The present application claims priority under 35 U.S.C. § 119(e)(1) to provisional application No. 60/908,712 filed on Mar. 29, 2007, the contents of which are incorporated herein by reference.

### BACKGROUND OF THE INVENTION

1. Technical Field

The present invention relates to antennae in general, and, in particular, to a conductor having two frequency-selective surfaces.

2. Description of Related Art

Antenna systems capable of providing independent operations in different directions have been widely utilized in microwave relay systems for long haul point-to-point applications (largely replaced by buried fiber optic cable in conventional systems), and, more recently, sectorized antenna systems for mobile telephony, or cellular telephones. Antenna systems capable of providing independent operations in different directions are typically large and mechanically complex, and are constructed of parabolic reflectors (as in microwave relay stations) or multiple metallic structures (as in cell antennas). Similarly, planar antennas have been utilized on the skin of aircraft and in massive phased array structures for electronic beam steering. Planar arrays have not been used in applications where independent operations are required in different directions.

Any arrangement of surfaces that provide high impedance for surface currents is referred to as a high impedance surface (HIS). If an electric field antenna is placed in close proximity to a HIS that includes a frequency-selective surface (FSS) in close proximity with a perfect electrical conductor (PEC), the energy reflected from the HIS will return in phase with the energy radiating away from the HIS, thereby amplifying the antenna signals. Such arrangement allows efficient, low-profile planar antennas and arrays to be constructed using pattern and etch techniques like those developed for printed circuit boards.

### SUMMARY OF THE INVENTION

In accordance with a preferred embodiment of the present invention, an antenna reflector system includes a first frequency-selective surface (FSS), a second FSS, and a perfect electrical conductor. While FSS structures vary, and can take many forms, in the implementation shown, both the first FSS and the second FSS have multiple holes (i.e., mesh like). The perfect electrical conductor is located between the first FSS and the second FSS.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of an antenna reflector system having multiple frequency-selective surfaces and a perfect electrical conductor, in accordance with a preferred embodiment of the invention;

FIG. 2 is a diagram of back-to-back high impedance surfaces, in accordance with a preferred embodiment of the present invention; and

FIG. 3 is a diagram of four independent antenna sub-spaces, in accordance with a preferred embodiment of the present invention.

### DETAILED DESCRIPTION OF A PREFERRED EMBODIMENT

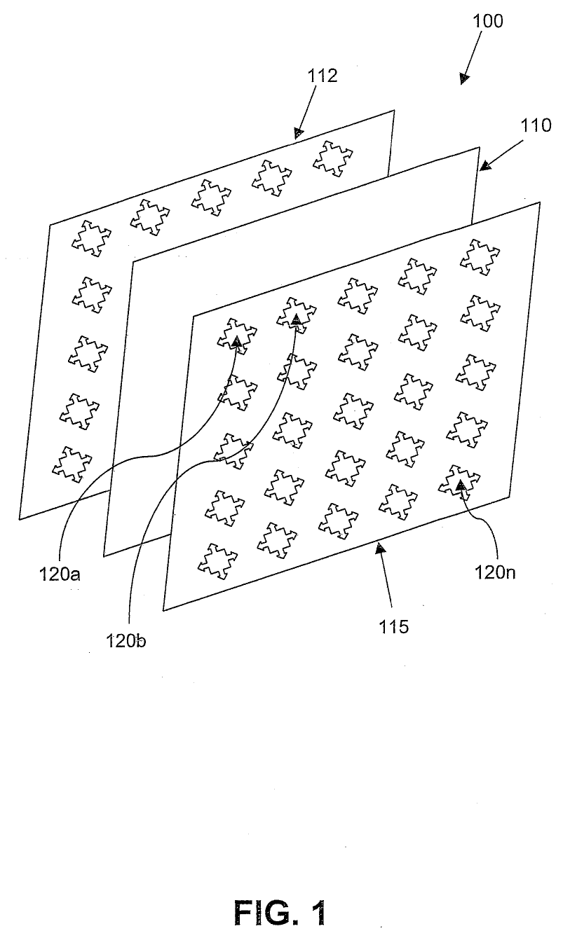

With reference now to the drawings, and in particular to FIG. 1, there is depicted a diagram of an antenna reflector system having multiple frequency-selective surfaces (FSSs), in accordance with a preferred embodiment of the invention. As shown, a two-sided antenna reflector 100 includes a perfect electrical conductor (PEC) 110 located between a FSS 112 and a FSS 115. As utilized herein, a PEC is defined as any conducting plane that carries surface current with minimal resistance, and a FSS is defined any surface that provides the correct wave impedance, through any means, to reflect electromagnetic waves, such that a reflected wave is substantially in phase with an incoming wave. A metallization layer in a printed wiring board is an example of a PEC. In FIG. 1, an FSS, such as FSS 115, is accomplished with a shield plane (e.g., a metallization layer) that is patterned with holes, such as multiple holes 120a-120n, to form a mesh.

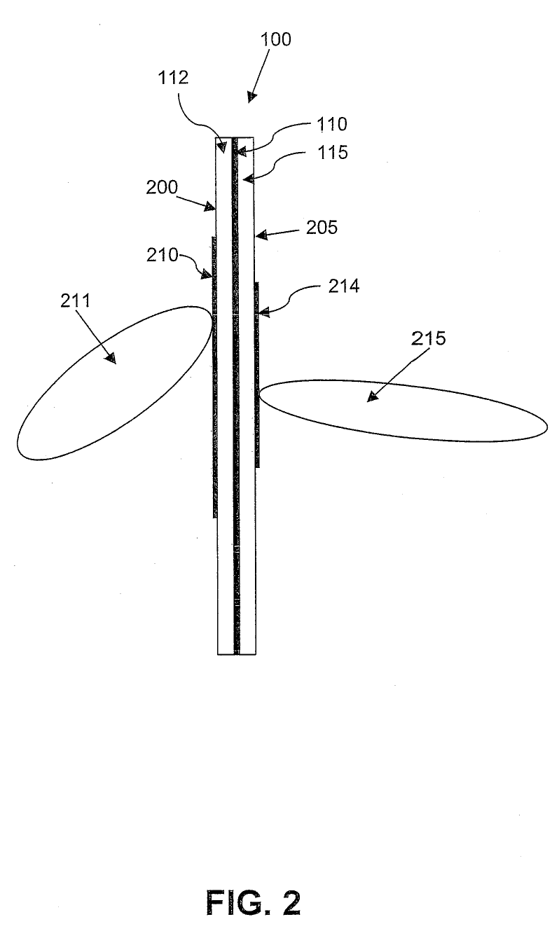

With reference now to FIG. 2, there is depicted a diagram of back-to-back high-impedance surfaces (HISs) on two-sided antenna reflector 100, in accordance with a preferred embodiment of the present invention. As shown, PEC 110 is placed parallel to, and in close proximity to, but not in electrical contact with FSS 112 and FSS 115. A first antenna pattern 211 is generated by a first antenna 210 that is located in close parallel proximity to a first HIS 200, and a second antenna pattern 215 is generated by a second antenna 214 that is located in close parallel proximity to a second HIS 205. First HIS 200 is formed by the location of FSS 112 being in close proximity to PEC 110. Similarly, second HIS 205 is formed by the location of FSS 115 being in close proximity to PEC 110. First HIS 200 and second HIS 205 can resonate at the same frequency or at different frequencies.

In an alternative embodiment, separate arrays of antennas can be located above first HIS 200 and second HIS 205, and each antenna array may have different steering and/or multiple-input multiple-output (MIMO) criteria. In yet another embodiment, the operating frequencies of antenna patterns 210 and 215 are sufficiently separated to enable the intervening conducting plane (i.e., PEC 110) to be removed, thereby reducing the number of metallization layers and reducing overall antenna system cost.

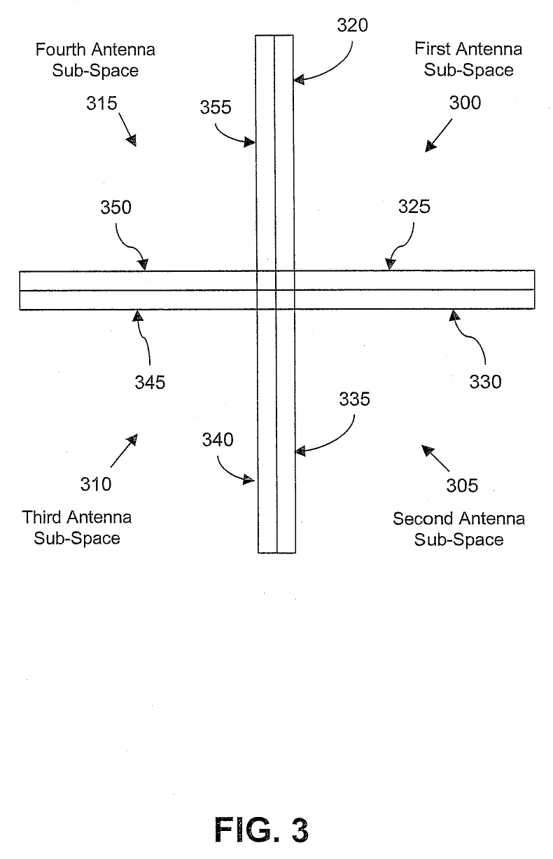

With reference now to FIG. 3, there is depicted a diagram of four independent antenna sub-spaces, in accordance with a preferred embodiment of the present invention. As shown, a first antenna sub-space 300, a second antenna sub-space 305, a third antenna sub-space 310, and a fourth antenna sub-space 315 are formed by two sets of back-to-back HISs that are positioned orthogonally to each other to form quadrants. Alternatively, the back-to-back HISs may be positioned at an angle other than 90°. In addition, more that two sets of back-to-back HISs may be utilized to form more than four independent antenna sub-spaces (e.g. three double-sided structures dividing a space into six antenna sub-spaces).

As shown in FIG. 3, first antenna sub-space 300 is bounded by HIS 320 and HIS 325. Second antenna sub-space 305 is bounded by HIS 330 and HIS 335. Third antenna sub-space 310 is bounded by HIS 340 and HIS 345. Fourth antenna sub-space 315 is bounded by HIS 350 and HIS 355. Up to four different antennas (not shown) or up to four different arrays of antennas (not shown) can operate independently and be phased to concentrate energy at any angle within antenna sub-spaces 300, 305, 310 and 315.

As has been described, the present invention provides an antenna reflector system having a frequency-selective surface. The present invention enables one or more antennas to be integrated into a coordinated antenna system, thereby providing significant size and cost advantages over conventional back-to-back antenna arrangements, such as horns or parabolic reflectors. The present invention enables the fabrication of low-cost, etched printed wiring board antenna reflectors useful in multiple applications, such as relay stations and sectorized antenna systems. The present invention provides excellent isolation (typically associated with back to back parabolic reflectors) at a fraction of the cost of conventional antenna reflector systems.

While the invention has been particularly shown and described with reference to a preferred embodiment, it will be understood by those skilled in the art that various changes in form and detail may be made therein without departing from the spirit and scope of the invention.

What is claimed is:

1. An antenna comprising:
a first frequency-selective surface (FSS) having a plurality of holes to form a mesh;
a second FSS having a plurality of holes to form a mesh; and
a perfect electric conductor located between said first FSS and said second FSS.

2. The antenna of claim 1, wherein said perfect electric conductor is any conducting plane that carries surface current with minimal resistance.

3. The antenna of claim 1, wherein said first FSS and said second FSS are any surface that provides wave impedance to reflect electromagnetic waves such that a reflected wave is substantially in phase with an incoming wave.

4. The antenna of claim 1, wherein said perfect electric conductor is in close proximity to but not in electrical contact with said first FSS and said second FSS.

5. The antenna of claim 1, wherein said antenna further includes a first antenna located in close parallel proximity to a first high-impedance surface for generating a first antenna pattern.

6. The antenna of claim 5, wherein said antenna further includes a second antenna located in close parallel proximity to a second high-impedance surface for generating a second antenna pattern.

7. The antenna of claim 6, wherein said first and second high-impedance surfaces can resonate at the same frequency or at different frequencies.
